(19) United States
(12) Patent Application Publication
(10) Pub. No.: US 2011/0298157 A1
(43) Pub. Date: Dec. 8, 2011

(54) Method of cleaning molds for producing tire profiles

(76) Inventor: Horst Vossen, Simmerath (DE)

(21) Appl. No.: 13/136,758

(22) Filed: Aug. 10, 2011

Related U.S. Application Data
(63) Continuation-in-part of application No. PCT/EP2010/000958, filed on Feb. 16, 2010.

(30) Foreign Application Priority Data
Feb. 17, 2009 (DE) DE 102009009201.3
May 17, 2009 (DE) DE 102009021697.9

(51) Int. Cl. B29C 33/72

(52) U.S. Cl. 264/402; 425/225

(57) ABSTRACT

In a method for cleaning profile molds for producing tire profiles on treads of vehicle tires, the profile molds are cleaned in rinsing suds by using ultrasound. The profile molds are moved successively through a pre-cleaning and a primary cleaning chamber between which they are rinsed in a rinsing bath. After cleaning in the primary cleaning chamber, the profile molds are checked with respect to remaining contaminants and valves disposed in air vent openings in the profile molds are inspected and loosened by ultrasound application to ensure their mobility. Subsequently, the profile molds are cleaned again. The invention also relates to an arrangement for carrying out the method.

This is a Continuation-In-Part application of pending international patent application PCT/EP2010/000958 filed Feb. 16, 2010 and claiming the priority of German patent applications 10 2009/009201 filed Feb. 17, 2009 and 10 2009/021697.4 filed May 17, 2009.

### BACKGROUND OF THE INVENTION

The invention relates to a cleaning method and a cleaning plant for cleaning profile molds which serve for producing tire profiles on treads of vehicle tires and which have openings for discharging air and gases when pressing the tire profiles, which openings are to be opened and closed by movable valves. The profile molds made from pressure- and temperature-resistant material represent the negative of the tire profile to be generated on the tread of the tire. The profile molds are cleaned in rinsing suds by using ultrasound.

For generating tire profiles it is known to press a green tire having a tread strip from rubber applied onto the carcass in a tire press (hot press) against a profile mold which surrounds the green tire in an annular manner. The profile mold consists of a plurality of individual mold segments which are placed next to each so as to form a closed ring. During pressing, the rubber composition of the tread strip of the green tire, which rubber composition consists of a mixture of natural and synthetic rubber and additives (for example soot, zinc oxide, antioxidants) for increasing abrasion resistance and ageing resistance of the tire, penetrates into the cavities of the mold segments. In the press, the profiled rubber composition is vulcanized at temperatures between 170° C. to 200° C. and a pressure of up to 22 bar. To ensure that the rubber composition can penetrate during molding into the cavities of the mold segments it is required to discharge the air present in the cavities and, where applicable, to discharge the gases generated during heating. For this purpose, the mold segments have openings on the back of their segments through which openings air and gases can escape from the cavities into the environment. Into these openings, valves are inserted which move against the spring force of mechanical valve springs in the openings and close the openings as soon as the rubber composition has filled the cavities of the mold segments. After vulcanization of the rubber composition, the mold segments are lifted off the finished tire and the tire is removed from the press. Subsequently, the press can be loaded again with a green tire.

High requirements are set for the quality of the tire profiles, in particular because of the road grip of the tire which depends on the formed profile. It is important that the cavities of the negative profiles of the molds are always freely accessible during the tire production and do not contain any material residues. For maintaining the molds it is thus provided to clean the molds in each case after empirically specified operating cycles. For this purpose, the profile mold segments—advantageously together with their mounting supports—are disassembled from the press and cleaned in, cleaning plants.

It is known to clean profile molds in rinsing solutions by using ultrasound in cleaning baths which are successively run through by the profile molds; see for example U.S. Pat. No. 6,615,852 B1 for cleaning resin molds in electrolytic cleaning liquid.

In JP 06262630 A and EP 1498247 A1, methods for cleaning vulcanization molds are described in which, after a first treatment step in which the molds are heated and the vapors which are subjected to a negative pressure during heating are extracted, the molds to be cleaned are cleaned with a jet of compressed air which contains particles. Subsequently, the molds are washed, wherein the washing process can be supported by ultrasound devices immersed into the washing liquid.

Also known is the cleaning of mold segments from aluminum using dry ice. Here, dry ice pellets from carbon dioxide (CO2) are blasted onto heated mold segments so as to remove adhering and potentially hardened vulcanized rubber residues from the cavities of the mold segments. The difficulty here is the cleaning of narrow cavities, in particular the openings in the back of the segment, and the removal of contaminants on valves and valve springs which are not or not sufficiently reached for dirt removal during the dry ice cleaning. However, an unhindered mobility of the valves is one of the essential requirements for a proper formation of the tire profiles.

It is therefore the object of the present invention to provide a method and arrangement of achieving a thorough cleaning of the molds overall including the openings and the valves as well as the valve springs disposed in the openings of the mold segments for unhindered discharge of air and gases during pressing.

### SUMMARY OF THE INVENTION

In a method for cleaning profile molds for producing tire profiles on treads of vehicle tires the profile molds are cleaned in rinsing suds by using ultrasound. The profile molds are moved successively through a pre-cleaning and a primary cleaning chambers between which they are rinsed in a rinsing bath. After cleaning in the primary cleaning chamber, the profile molds are checked with respect to remaining contaminants and valves disposed in air vent openings in the profile molds are inspected and loosened to ensure their mobility by using ultrasound. Subsequently, the profile molds are cleaned again.

The invention also relates to an arrangement for carrying out said method. The cleaning arrangement for the mold segments comprises an inspection unit arranged downstream of the primary cleaning chamber for checking for any remaining contaminants of the profile molds, wherein for loosening the valves of the profile molds and for restoring their mobility, at least one ultrasound device is used in the inspection unit.

An exemplary embodiment of the invention will be described hereinafter with reference to the accompanying drawings:

### BRIEF DESCRIPTION OF THE DRAWINGS

FIG. 1 shows a detail of a mold segment, and

FIG. 2 shows a flow diagram of a cleaning arrangement.

### DESCRIPTION OF AN EXEMPLARY EMBODIMENT

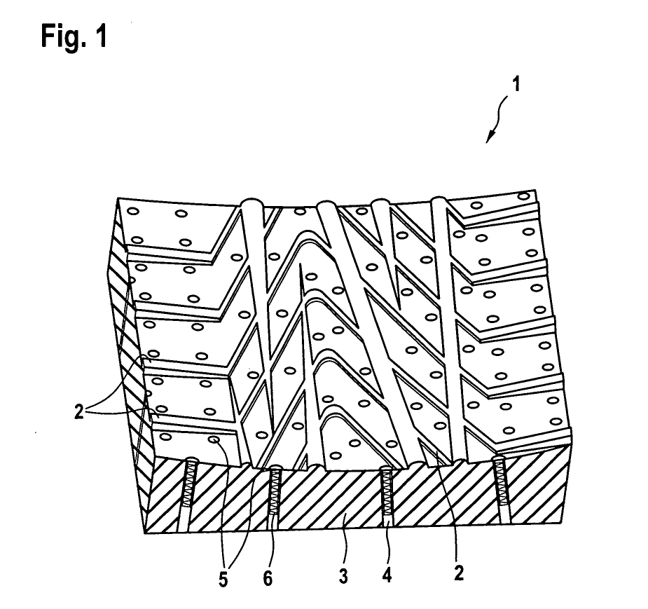

In FIG. 1 of the drawing, a detail of an individual mold segment 1 for a profile mold for generating a tire profile of vehicle tires is shown schematically. The profile mold, which is composed of a plurality of mold segments 1, represents the negative of the tire profile; the raised mold parts 2 in the profile surface of the mold segments 1 correspond to the recesses of the tire profile on the tread of the tire. For producing the tire profile, the mold segments are placed in a tire press (hot press) onto a green tire on the rubber tread strip of the same, which tread strip is applied to the circumference of the green tire. During hot pressing, the rubber composition of the tread strip deforms corresponding to the profile surface of the mold segments 1. To ensure that the air present in the forming cavities between rubber composition and profile surface of mold segments and gases potentially developing during heating can flow out of the cavities, openings 4 are provided on the mold segment 1 on the back 3 of the segment, which openings, for discharging air and gases, are spatially connected on the one side to the profile surface of the mold segments and open out on the other side into the external environment of the mold segments into which the air and the gases can flow. In the openings 4, valves 5 are disposed. Each valve 5 has a pin which moves in the valve housing against the spring force of a mechanical valve spring 6. The valve spring 6 has a mean diameter of approximately 1 mm. The valve spring and the valve housing are dimensioned accordingly. In the exemplary embodiment, the outer diameter of the valve housing in the opening 4 is approximately 3 mm. At the beginning of the pressing process, the valves 5 are open so that air and gases can flow out; they close when the rubber composition has filled the profile surface of the mold segments 1 and the vulcanization of the rubber composition begins.

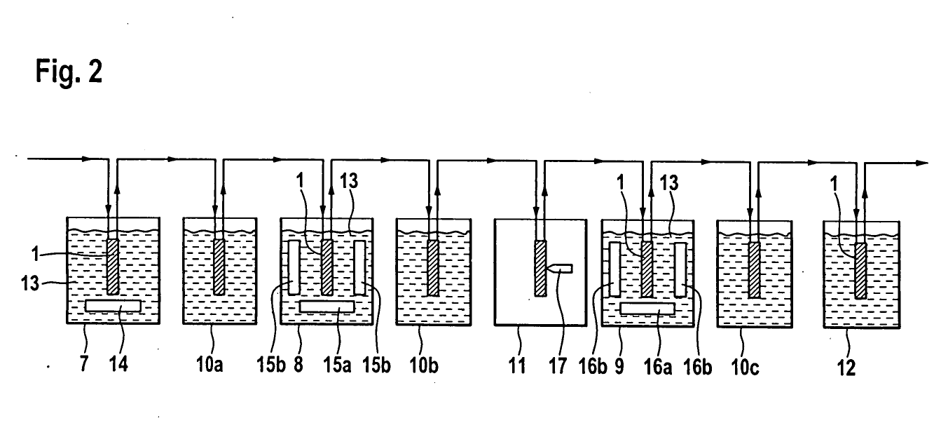

In order to ensure the required quality of the tire profile to be formed, the profile molds or the individual mold segments 1 of which the profile mold is composed are generally regularly cleaned after a specified operating time in a tire press and completion of empirically determined operating cycles. FIG. 2 of the drawing represents schematically a flow diagram of a cleaning arrangement for cleaning mold segments 1.

For cleaning the mold segments 1, the arrangement according to FIG. 2 has three cleaning chambers 7, 8, 9 connected in series; a first pre-cleaning chamber 7, a primary cleaning chamber 8 and a secondary cleaning chamber 9 which are to be successively run through by each of the mold segments to be cleaned. The transfer direction of the mold segments through the cleaning plant is marked in FIG. 2 by arrows on a fictitious transport path. Following each cleaning chamber, rinsing baths 10a, 10b, 10c are provided. The primary cleaning chamber 8 with rinsing bath 10b is followed by an inspection unit 11. A final bath 12 completes the cleaning of the mold segments 1.

In the cleaning chambers, the mold segments made from aluminum are dipped into the rinsing suds 13 which are heated in the exemplary embodiment. The mold segments are cleaned in the rinsing suds under the action of ultrasound. For generating the ultrasound, all chambers 7, 8, 9 have ultrasound devices. In the chambers, ultrasound transducers 14, 15a, 15b, 16a, 16b are used which are operated by ultrasound generators which are not illustrated in FIG. 2. In the pre-cleaning chamber 7, the ultrasound transducer 14 is installed in the rinsing suds in the bottom region of the chamber below the mold segments 1 which are dipped into the rinsing suds 13 for cleaning. Thus, the mold segments are treated in the pre-cleaning chamber 7 with sound coming from the bottom of the chamber.

After the treatment in the pre-cleaning chamber 7, the mold segments 1 are rinsed in the rinsing bath 10a, which in the exemplary embodiment is filled with heated rinsing water, and are freed from the first contaminants dissolved in the pre-cleaning chamber 7.

In the downstream primary cleaning chamber 8, one of the ultrasound transducers, the ultrasound transducer 15a is arranged again in the bottom region of the primary cleaning chamber 8. Moreover, ultrasound transducers 15b are located in the wall region of the primary cleaning chamber in the exemplary embodiment in such a manner that the mold segments 1 dipped into the rinsing suds are treated with sound waves directed towards their surface having the negative tire profile surface, that is, toward their profile surface. In the primary cleaning chamber 8 too, the mold segments 1 are treated in heated rinsing suds, the consistency and temperature of which in the exemplary embodiment corresponds to the rinsing suds in the pre-cleaning chamber 7.

In the exemplary embodiment, two ultrasound transducers 15b are installed in the wall region of the primary cleaning chamber 8. In this manner, at least two or more mold segments arranged next to each other can be simultaneously treated with sound on their profile surface. The dimensions of the cleaning and rinsing chambers are to be designed according to the desired throughput of mold segments through the cleaning arrangement.

After the primary cleaning in the primary cleaning chamber 8, the mold segments 1 are rinsed again in the rinsing bath 10b with heated rinsing water and are subsequently dried.

After this, a check for the achieved cleaning takes place in the inspection unit 11. In the exemplary embodiment, no flushing medium is used for the treatment of the mold segments. The inspection unit remains dry. Insufficiently cleaned areas of the mold segments 1 are treated with an ultrasound device 17 during the check. This relates in particular to the valves 5 which are individually inspected, moved and adequately loosened with respect to the mobility of valve pins and valve springs 6 in the valve housing. In the exemplary embodiment, a manually operable ultrasound device having an ultrasonic head adapted to the valve dimension is used here as ultrasound device 17.

After checking the mold segments and loosening the valve pins in the valves 5, the mold segments are cleaned again under the action of ultrasound in the secondary cleaning chamber 9 in heated rinsing suds. In the same manner as the primary cleaning chamber 8, the secondary cleaning chamber 9 has ultrasound transducers in the bottom region as well as in the wall region of the chamber. In the bottom region of the secondary cleaning chamber 9, ultrasound transducers 16a are used and in the wall region, ultrasound transducers 16b are used.

Here again, the rinsing suds 13 in the secondary cleaning chamber 9 corresponds with respect to its consistency and temperature to the consistency and temperature of the rinsing suds in the pre-cleaning and primary cleaning chambers.

After the treatment in the secondary cleaning chamber 9, the mold segments 1 are rinsed again, first with water in the rinsing chamber 10c and subsequently in the exemplary embodiment with preserving agent in the final bath 12.

In the exemplary embodiment, the cleaning arrangement is operated as follows:

In the cleaning chambers 7, 8, 9, in alkaline rinsing solution (rinsing suds with pH 12.5 (10%) and pH 7.1 (2%)), 40 kHz immersible transducers are used in the bottom region and 30 kHz immersible transducers are used in the wall region as ultrasound devices. The rinsing suds temperature is approximately 80° C. The immersible transducers are operated for approximately 15 min. The ultrasonic vibration is to be selected in such a manner that cavitation is avoided.

In the rinsing baths 10 (10a, 10b, 10c), the rinsing water temperature is approximately 40° C.

In the inspection unit 11, a manually operatable ultrasound device 17 having an ultrasonic head with 50/60 kHz adapted to the valve pin is used.

The cleaned profile molds can be preserved at room temperature (RT) in the final bath 12 with a rinsing agent with pH 9.1 (0.25%).

Reference list

| | |
|---|---|
| 1 | Detail of a mold segment |
| 2 | Mold parts |
| 3 | Back of segment |
| 4 | Opening |
| 5 | Valve |
| 6 | Valve spring |
| 7 | Pre-cleaning chamber |
| 8 | Primary cleaning chamber |
| 9 | Secondary cleaning chamber |
| 10a, 10b, 10c | Rinsing bath |
| 11 | Inspection unit |
| 12 | Final bath |
| 13 | Rinsing suds |
| 14, 15a, 15b, | Ultrasound transducer |
| 16a, 16b | |
| 17 | Manually operable ultrasound device |

What is claimed is:

1. A cleaning method for cleaning profile molds for producing tire profiles on treads of vehicle tires, the profile molds having recesses with openings for discharging air and gases when pressing the tire profiles, and the openings including movable valves which are to be opened and closed, the method comprising the steps of: cleaning the profile molds in rinsing suds in a primary cleaning chamber by applying ultrasound, checking the valves after the first cleaning step for remaining contaminants and inspecting the valves and, if stuck loosening the valves to ensure the mobility of the same by using ultrasound, and subsequently again cleaning the profile molds in a secondary cleaning chamber.

2. The cleaning method according to claim 1, wherein prior to the cleaning in the primary cleaning chamber, the profile molds are passed through a pre-cleaning chamber.

3. The cleaning method according to claim 2, wherein in each case after passage through the pre-cleaning as well as the primary cleaning and the secondary cleaning chambers, the profile molds are rinsed in a rinsing bath.

4. The cleaning method according to claim 1, wherein the rinsing suds are heated.

5. A cleaning arrangement for cleaning profile molds for producing tire profiles on treads of vehicle tires, the molds having openings for discharging air and gases when pressing the tire profiles, with movable valves disposed in the openings for opening and closing the openings, the cleaning arrangement comprising a primary cleaning chamber (8) which, for cleaning the profile molds in rinsing suds (13), includes ultrasound transducers (15a, 15b) which generate ultrasound and are used in the rinsing suds, for the profile molds to be cleaned in the primary cleaning chamber (8), an inspection unit (11) arranged downstream of the primary cleaning chamber (8) for checking for remaining contaminants in the profile molds, an inspection unit (11) for checking the mobility of the valves and which, for loosening the same, includes an ultrasound device (17), and a secondary cleaning chamber (9) arranged downstream of the inspection unit (11) for a secondary cleaning of the profile molds.

6. The cleaning arrangement according to claim 5, wherein a pre-cleaning chamber (7) is arranged upstream of the primary cleaning chamber (8).

7. The cleaning arrangement according to claim 5, wherein, downstream of each cleaning chamber (7, 8, 9), a rinsing bath (10a, 10b, 10c) is arranged for rinsing profile molds cleaned earlier in said cleaning chamber

8. The cleaning arrangement according to claim 5, wherein the cleaning chambers (7, 8, 9) are filled with heatable rinsing suds (13) in which the profile molds are placed for cleaning and ultrasound transducers (14, 15a, 15b, 16a, 16b) are installed in the cleaning chambers (7, 8, 9) at least at one of the bottom and the side walls of the cleaning chambers (7, 8, 9).
